(19) United States
(12) Patent Application Publication
(10) Pub. No.: US 2007/0239776 A1
(43) Pub. Date: Oct. 11, 2007

(54) Bonded material monitoring system and method

(75) Inventors: Neil Chen, Taipei (TW); Celn Chen, Taipei (TW); Hiweed Leng, Taipei (TW); Alan Lo, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/391,925

(22) Filed: Mar. 28, 2006

(51) Int. Cl. G06F 17/00

(52) U.S. Cl. 707/104.1

(57) ABSTRACT

A bonded material monitoring system is connected with an enterprise resource planning (ERP) system and a custom system. The bonded material monitoring system includes a material tracking module for inputting inquiring instructions of materials ready to be inquired and receiving material data corresponding to the inquiring instructions and provided by the logistic management database, and calculating and gathering statistics of the material data to generate a material consumption table; and a material checking module for generating a theoretic stock values based on the material consumption table generated by the material tracking module, performing an inquiring process based on the theoretic stock values, the material data provided by the logistic management database and the custom sheet data provided by the material data, and generating abnormal messages and an abnormal analysis report when inquiring results mismatch.

### BACKGROUND OF THE INVENTION

1. Field of the Invention

This invention relates to bonded material monitoring systems, and more particularly, to a bonded material monitoring system connected to an enterprise resource planning (ERP) system and a custom system.

2. Description of Related Art

For trading and processing enterprises, raw material, components, devices, packaging materials and consumptive materials manufactured by the enterprises are in a tax-bonded form in custom departments. The custom departments, in accordance with management regulations related to the trade and processing enterprises, manage these bonded materials (including the above raw material, components, devices, packaging materials and consumptive materials) strictly. Accordingly, the enterprises have to accept the management of the custom departments anytime. The custom departments monitors the bonded materials by the use of a method for asking the enterprises to provide operation data of materials and managing the enterprises based on the operation data.

Currently, practical steps adopted by the custom departments to manage the enterprise include (1) the custom departments set priority goods to which the custom departments have to pay attention based on production material list and product list of the enterprise; (2) the enterprise provides output/input data and production labor sheet data of the enterprise every day; (3) the custom departments calculate current theoretic stock of goods of the enterprise based on the output/input data and labor sheet data provided by the enterprise every day; (4) the enterprise provides enterprise resource planning (ERP) stock data every a predetermined period (ten days in general); (5) the custom departments compares the calculated theoretic stock with the ERP stock based on a predetermined difference ratio, and when a difference ratio between the theoretic stock and the ERP stock is larger than the predetermined difference ratio, the custom departments take this as an abnormal condition and perform on the enterprise special processes. For example, custom personnel enter a factory of the enterprise and perform a spot-checking process or ask the enterprise to provide an abnormal condition explanation to interpret the reasons why differences exist; (6) the custom departments can further track the usage and stock of materials of the enterprise, and check constitution conditions of products of the enterprise and analyze real production condition of the enterprise.

Based on the above steps, the custom departments complete a preliminary monitoring process on the production of the enterprise, and form a determent to the enterprise. Currently, some problems exist in the above steps. For example, the custom departments perform the preliminary monitoring process on the enterprise based on logistic data declared by the enterprise only, without referring custom sheet data having legal meanings. Therefore, the custom departments perform a partial monitoring process on the enterprise. Moreover, internal units of the enterprise might not follow rules exactly to operate in development business, resulting that a custom department finds that a lot of bonded materials are lost when performing a cancellation process on account books. For example, the bonded materials are changed due to engineer change notice (ECN) and manufactory notice (MN) and are different from real numbers of bonded materials. In result, real bonded quality will not be shown, and the bonded enterprise might loss the qualification of bonded enterprise because the bonded enterprise did not pass the inquiry of the custom departments. Further, the enterprise has to interpret to the custom departments the reasons why these conditions happen, and pay high tax for the lost bonded materials, which makes a great impact on the enterprise.

Therefore, how to provide an bonded material monitoring technique for an enterprise to prevent from the drawbacks of the prior art is becoming one of the most important issues in the art.

### SUMMARY OF THE INVENTION

In views of the above-mentioned problems of the prior art, it is a primary objective of the present invention to provide a bonded material monitoring system and method for monitoring bonded materials of an enterprise in time.

To achieve the above-mentioned and other objectives, a bonded material monitoring method is provided according to the present invention. The method is designed for working with an ERP system having a logistic management database and a custom system having a custom management database, and tracking and inquiring materials ready to be inquired. The logistic management database is used for storing material data including input data, output data, stock data, initial stock data and labor sheet data. The custom management database is used for storing custom sheet data including import custom sheet data and export custom sheet data. The bonded material monitoring method includes inputting inquiring instructions of the materials ready to be inquired; receiving material data corresponding to the inquiring instructions; calculating bonded material values based on the material data; gathering statistics of the bonded material values and generating a material consumption table; calculating theoretic stock values based on the material consumption table; calculating difference ratios between the theoretic stock values and the material data and between the theoretic stock values and the custom sheet data, and generating abnormal messages when comparing results mismatch; and generating an abnormal analysis report based on the abnormal messages.

Moreover, the present invention further provides a bonded material monitoring system, which is connected with an enterprise resource planning system having a logistic management database and a custom system having a custom management database. The bonded material monitoring system includes a material tracking module and a material checking module for tracking and inquiring materials ready to be inquired.

The material tracking module is used for receiving and calculating and gathering statistics of the material data provided by the logistic management database to generate a material consumption table, allowing users to track and inquire the materials ready to be inquired. The material tracking module includes a data collecting unit, an inquiring unit, a calculating unit and a statistic unit.

The inquiring unit is used for inputting inquiring instructions of the materials ready to be inquired to inquire the material data corresponding to the inquiring instructions.

The data collecting unit is used for receiving the material data corresponding to the inquiring instructions and provided by the logistic management database.

The calculating unit is used for calculating bonded material values based on the material data received by the data collecting unit.

The statistic unit is used for gathering statistics of the bonded material values generated by the calculating unit, and generating a material consumption table.

The above material checking module is used for generating theoretic stock values based on the material consumption table generated by the material tracking module, performing a checking process based on the theoretic stock values, the material data provided by the logistic management database and the custom sheet data provided by the material data, and generating abnormal messages and an abnormal analysis report when checking results mismatch. The material checking module includes a stock calculating unit, a difference ratio calculating unit, a comparing unit and an analyzing unit.

The stock calculating unit is used for generating the theoretic stock values based on the material consumption table generated by the material tracking module.

The difference ratio calculating unit is used for calculating difference ratios between the theoretic stock values and the material data provided by the logistic management database, and between the theoretic stock values and the custom sheet data provided by the custom management database.

The comparing unit is used for comparing the difference ratios generated by the difference ratio unit with a predetermined difference ratio, and generating the abnormal messages when comparing results mismatch.

The analyzing unit is used for analyzing the abnormal messages and generating the abnormal analysis report.

The bonded material monitoring system of the present invention further includes a material canceling module for perform cancellation and overdue tax-paying processes based on the material data provided by the logistic management database and the custom sheet data provided by the material data.

Compared with the prior art, the bonded material monitoring system is connected with the ERP system and the custom system, allowing an enterprise to track data of bonded materials of the enterprise effectively and inquire, along with formal custom sheet data having legal meanings, bonded materials of the enterprise, so as to achieve the objective of monitoring and bonded material monitoring and early-warning of bonded materials of the enterprise to satisfy the monitoring demands of custom or management departments on the bonded materials of the enterprise and prevent the custom department, when monitoring the bonded materials of the enterprise, from finding any difference between stock data of the ERP system and custom data provided by the enterprise to the custom department.

Therefore, because the bonded material monitoring system of the present invention can monitor the bonded materials effectively and prevent the above abnormal conditions from happening, the enterprise does not have to explain to the custom department about the bonded materials and can save time on time-consuming processes of remedying the above abnormality.

### BRIEF DESCRIPTION OF DRAWINGS

The invention can be more fully understood by reading the following detailed description of the preferred embodiments, with reference made to the accompanying drawings, wherein:

FIG. 1 is a flow chart of a bonded material monitoring method of a first embodiment according to the present invention;

FIG. 2 is a functional block diagram of a bonded material monitoring system corresponding to the bonded material monitoring method shown in FIG. 1;

FIG. 3A is a functional block diagram of a material tracking module of the bonded material monitoring system shown in FIG. 2;

FIG. 3B is a functional block diagram of a material checking module of the bonded material monitoring system shown in FIG. 2;

FIG. 4 is a schematic diagram illustrating that the material checking module of the present invention performs an inquiring method for inquiring output/input data;

FIG. 5 is a schematic diagram of a merging relation according to the present invention; and

FIG. 6 is a functional block diagram of a bonded material monitoring system of a second embodiment according to the present invention.

### DETAILED DESCRIPTION OF PREFERRED EMBODIMENTS

The following illustrative embodiments are provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

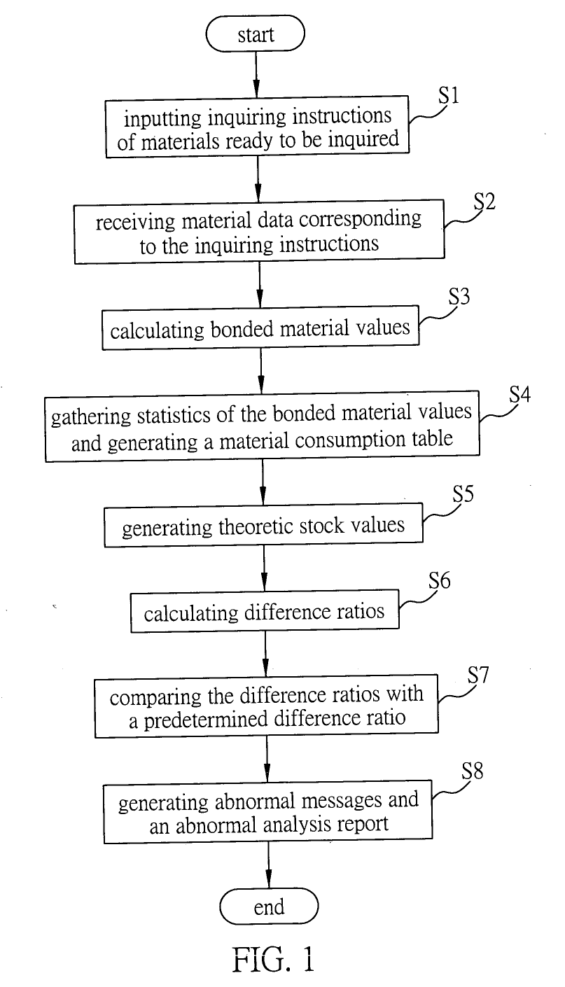

FIG. 1 is a flow chart of a bonded material monitoring method of a first embodiment according to the present invention. The bonded material monitoring method is used for, along with an enterprise resource planning (ERP) system having a logistic management database and a custom system having a custom management database, tracking and inquiring materials ready to be inquired. The logistic management database is used for storing material data of input data, output data, stock data, initial stock data (also called checked stock data) and labor sheet data (including labor sheet consumption data and labor sheet production data) or material merging relations of material number levels, merging serial number levels, item name levels and custom number levels. The custom management database is used for storing import custom sheet data and export custom sheet data. The bonded material monitoring method comprises

step 1 of inputting inquiring instructions of the materials ready to be inquired;

step 2 of receiving material data corresponding to the inquiring instructions;

step 3 of calculating bonded material values based on the material data;

step 4 of gathering statistics of the bonded material values and generating a material consumption table;

step 5 of generating theoretic stock values based on the material consumption table;

step 6 of calculating difference ratios between the theoretic stock values and the material data and the theoretic stock values and the custom sheet data;

step 7 of comparing the difference ratios with a predetermined difference ratio, and generating abnormal messages if comparing results mismatch; and

step 8 of generating abnormal analysis report based on the abnormal messages.

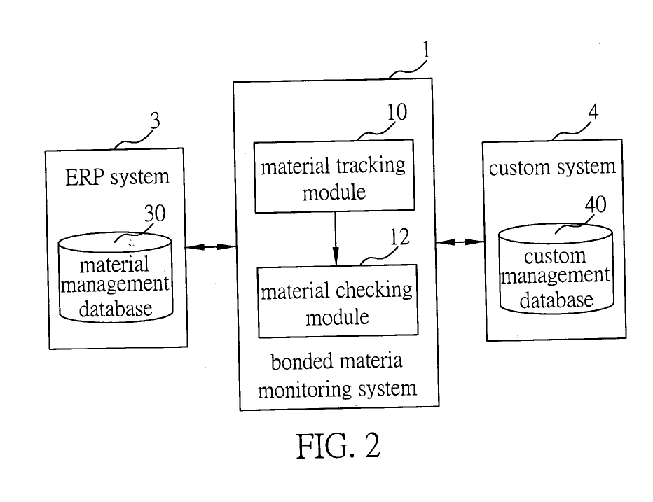

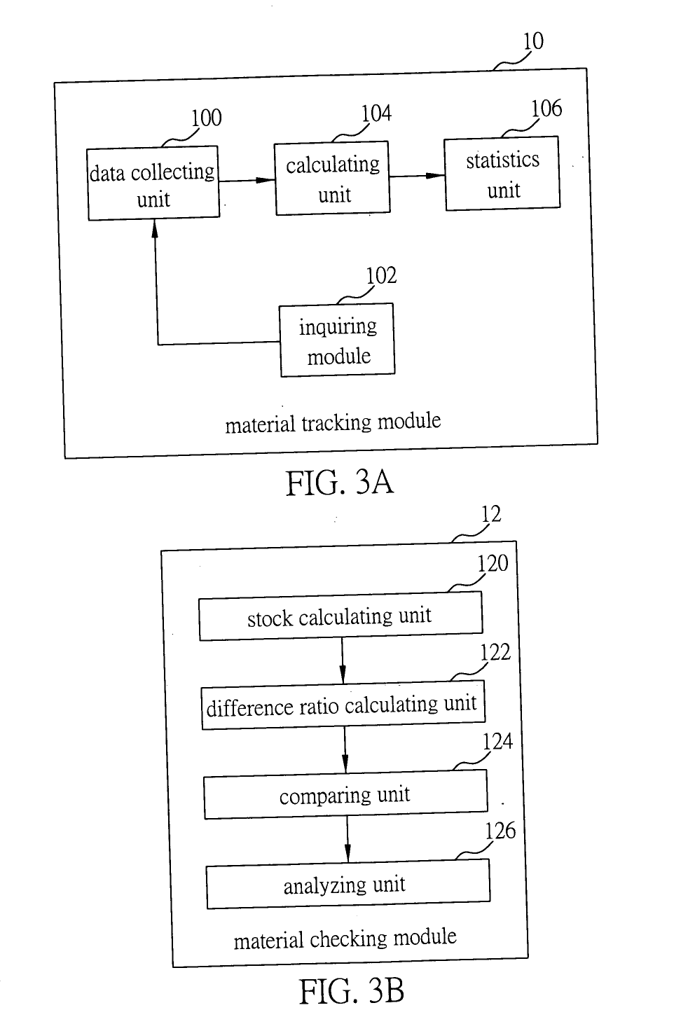

FIG. 2 is a functional block of a bonded material monitoring system 1 corresponding to the bonded material monitoring method shown in FIG. 1. FIG. 3A is a functional block diagram of a material tracking module 10 of the bonded material monitoring system 1. FIG. 3B is a functional block diagram of a material checking module 12 of the bonded material monitoring system 1. As shown in FIG. 2, the bonded material monitoring system 1 is connected between an enterprise resource planning system 3 having a logistic management database 30 and a custom system 4 having a custom management database 40. The bonded material monitoring system 1 comprises the material tracking module 10 and the material checking module 12, and is used for tracking and inquiring materials ready to be inquired.

The material tracking module 10 is used for receiving the material data of the input data, the output data, the initial stock data, stock data and labor sheet data provided by the logistic management database 30, and calculating and gathering statistics of the material data to generate the material consumption table, allowing users to track and inquire the materials ready to be inquired. The material tracking module 10 comprises a data collecting unit 100, an inquiring unit 102, a calculating unit 104 and a statistics unit 106.

The inquiring unit 102 is used for users to input the inquiring instructions of the materials ready to be inquired and to inquire the material data (such as the input data, the output data, the stock data, the initial stock data or the labor sheet data) corresponding to the inquiring instructions.

According to the first embodiment, the inquiring unit 102 is an operation interface, which provides selection items of initial stock, stock, output/input, and labor sheet consumption for users to inquire the materials ready to be inquired. The users are allowed to select at least one of the selection items on the operation interface, and input the inquiring instruction to the operation interface, to track and inquire the material data as a whole. The inquiring instructions comprise varieties of information, such as album numbers of materials, merging serial numbers in merging relations, material numbers of bonded materials, labor sheet number, stock time, custom sheet number or material numbers of productions.

The data collecting unit 100 is used for collecting the material data (i.e. the input data, the output data, the stock data, the initial stock data and labor sheet data) corresponding to the inquiring instructions and provided by the logistic management database 30.

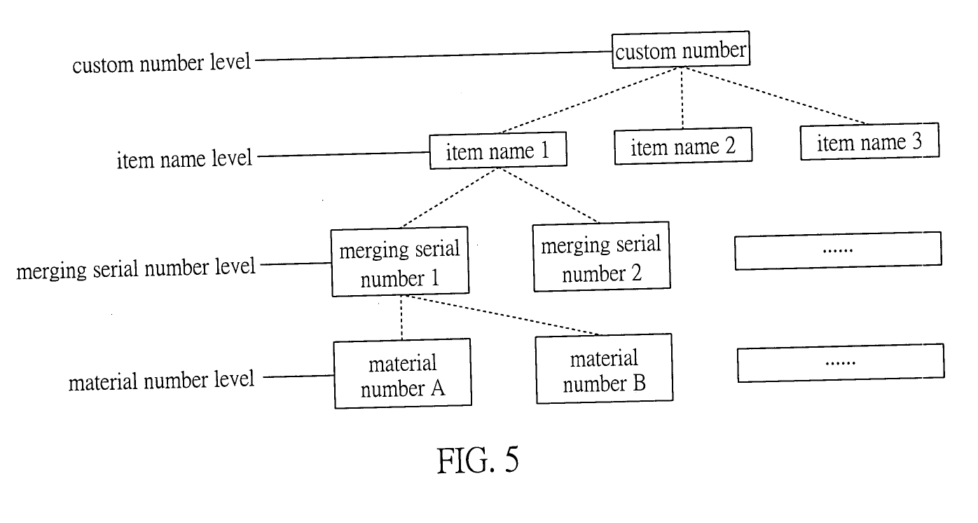

The calculating unit 104 is used for calculating bonded material values based on the material data received by the data collecting unit 100. In other words, the calculating unit 104 calculates initial stock numbers, current import numbers, current withdraw numbers, current input numbers (indicating the input of semi-finished and finished products), labor production numbers (indicating production input of labor sheet and negative item labor sheet output), other consumption, labor consumption (indicating the production input of labor sheet and the negative item labor sheet output), current sale numbers and material reciprocal numbers of current enterprise bonded materials based on input data, output data, labor sheet data received by the data collecting unit 100, and on a merging relation (shown in FIG. 5) of initial time (last stock checked time) of the initial stock data. The other consumption comprise positive other consumption (+), which are determined based on output records and output types of the output data, and negative other consumption (−), which are determined based on input records and input types of the input data. The current sale numbers comprise positive current sale numbers (+), which are determined based on the output records and output types of the output data, and negative current sale numbers (−), which are determined based on the input records and input types of the input data. The material reciprocal numbers comprise positive material reciprocals (+), which are determined based on the input records and input types of the input data, and negative material reciprocals (−), which are determined based on the output records and output types of the output data.

The statistics unit 106 is used for gathering statistics of bonded material values generated by the calculating unit 104, and generating the material consumption table. In other words, the statistics unit 106 gathers statistics of the initial stock numbers, the current import numbers, the current withdraw number, the current input numbers, the labor sheet production numbers, the other consumption, the labor sheet consumption, the current sale numbers and the material reciprocal numbers generated by the calculating unit 104 to generate the material consumption table. The material consumption table comprises the above initial stock numbers, the current import numbers, the current withdraw numbers, the current input numbers, the labor sheet production numbers, the other consumption (including the positive other consumption (+) and the negative other consumption (−)), the labor sheet consumption, the current sale numbers (including the positive current sale numbers (+) and the negative current sale numbers (−)), and the material reciprocal numbers (including the positive material reciprocal (+) and the negative material reciprocal (−)), allowing users to inquire corresponding data and the material checking module 12 to check and analyze the materials.

The material checking module 12 first generates the theoretic stock values based on the material consumption table generated by the material tracking module 10, then inquires the materials based on the theoretic stock values, the material data provided by the logistic management database 30, and the custom sheet data provided by the custom management database 40, and generates the abnormal messages and the abnormal analysis report when the inquiring results mismatch. The material checking module 12 comprises a stock calculating unit 120, a difference ratio calculating unit 122, a comparing unit 124 and an analyzing unit 126.

The stock calculating unit 120 is used for generating the theoretic stock values based on the material consumption table generated by the material tracking module 10. In other words, the stock calculating unit 120 acquires the theoretic stock values based on the data listed on the material consumption table formed by the material tracking module 10 in accordance with an equation:
theoretic stock values=initial numbers+current import numbers−current withdraw numbers+current input−positive other consumption (+)+negative other consumption (−)−positive current sale numbers (+)+negative current sale numbers (−)+positive material reciprocal numbers (+)−negative material reciprocal numbers (−)+labor sheet production−labor sheet consumption.

The difference ratio calculating unit 122 is used for calculating difference ratios between the theoretic stock values and the material data provided by the logistic management database 30, and between the theoretic stock values and the custom sheet data provided by the custom management database 30. In other words, the difference ratio calculating unit 122 calculates a first difference ration D1 between the theoretic stock values and the stock data (i.e. real stock), a second difference ratio D2 between the output data and the export custom data of the custom sheet data, or a third difference ratio D3 between the input data and the import custom data of the custom sheet data.

The comparing unit 124 compares the difference ratios generated by the difference ratio calculating unit 122 with a predetermined difference ratio, and generates the abnormal messages when the comparing results mismatch. In other words, the comparing unit 124 compares the predetermined difference ratio with the difference ratios D1, D2 and D3 generated by the difference ratio calculating unit 122, and generates the abnormal messages as an alarm when the comparing results mismatch.

The analyzing unit 126 is used for analyzing the abnormal messages generated by the comparing unit 124, and generating the abnormal analysis report. In other words, the analyzing unit 126 analyzes the abnormal messages generated by the comparing unit 124 and generates the abnormal analysis report, and provides the abnormal analysis report to corresponding business operation departments. Further, the analyzing unit 126, when analyzing that the comparing results are matched, generates a normal working report, allowing policy makers of the enterprise to understand operation conditions of current bonded materials of the enterprise and takes these reports as bases for planning future development.

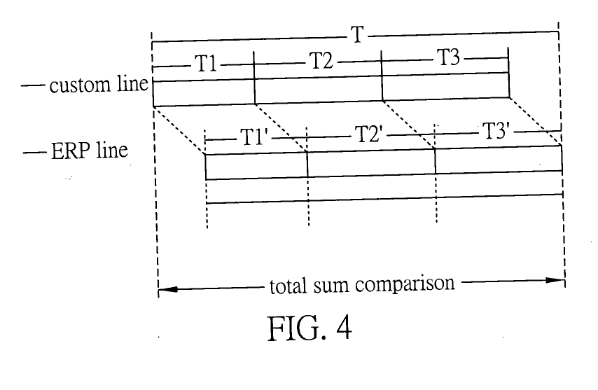

According to the first embodiment, the material checking module 12 checks output/input numbers of materials in two ways. Please refer to FIG. 4, which illustrates in a predetermined time period T an enterprise utilizes the custom system 4 to perform a custom line of import/export custom and the enterprise resource planning system 3 to perform output/input processes on materials after custom. Because the output/input processes can not be performed on the materials unless they are after custom, the above output/input line lags the custom line by time ΔT.

A first way is one-on-one comparing checking way. During the above time period T, each of the custom sheet data of the custom system 4 are compared with output/input numbers of corresponding bonded custom materials of the enterprise resource planning system 3 one on one. In other words, custom numbers of the custom sheet data of the custom system 4 in time T1, T2 and T3 are compared with output/input numbers of the enterprise resource planning system 3 in time T1′, T2′ and T3 one on one, so as to check the custom numbers of each of the custom sheet data and output/input numbers of the corresponding output/input data of the enterprise, and allow the enterprise to find and solve problems and prevent custom personnel from finding that these two are different.

A second way is total sum comparing checking way. A total sum of the custom numbers of all of the custom sheet data applied by the enterprise through the custom system 4 during the time period T is compared with a total sum of the output/input data of the enterprise resource planning system 3. In other words, a total sum of output/input custom numbers during the time period T is compared with corresponding input total sum and output total sum of the enterprise resource planning system 3.

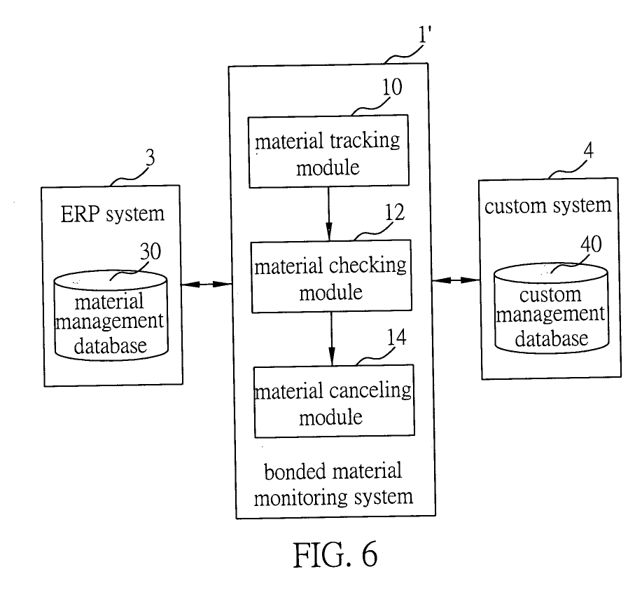

FIG. 6 is a functional block diagram of a bonded material monitoring system 1′ of a second embodiment according to the present invention. In addition to the material tracking module 10 and the material checking module 12, the bonded material monitoring system 1′ further comprises a material canceling module 14 for performing cancellation and overdue tax-paying processes based on the material data provided by the logistic management database 30 and the custom sheet data provided by the custom management database 40. In other words, the material canceling module 14 performs the cancellation process based on the output data, the input data, the stock data, the initial stock data and the labor sheet data provided by the logistic management database 30 and the custom sheet data provided by the custom management database 40, allowing an enterprise to perform the cancellation and overdue tax-paying processes on materials based on cancellation results of the material canceling module 14.

Compared with the prior art, the bonded material monitoring system is connected with the ERP system and the custom system, allowing an enterprise to track data of bonded materials of the enterprise effectively and inquire, along with formal custom sheet data having legal meanings, bonded materials of the enterprise, so as to achieve the objective of monitoring and bonded material monitoring and early-warning of bonded materials of the enterprise to satisfy the monitoring demands of custom or management departments on the bonded materials of the enterprise and prevent the custom department, when monitoring the bonded materials of the enterprise, from finding any difference between stock data of the ERP system and custom data provided by the enterprise to the custom department. Therefore, because the bonded material monitoring system of the present invention can monitor the bonded materials effectively and prevent the above abnormal conditions from happening, the enterprise does not have to explain to the custom department about the bonded materials and can save time on time-consuming processes of remedying the above abnormality.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. A bonded material monitoring system for connecting with an enterprise resource planning (ERP) system having a logistic management database and a custom system having a custom management database and tracking and inquiring materials ready to be inquired, the logistic management database being used for storing material data including input data, output data, stock data, initial stock data and labor sheet data, the custom management database being used for storing custom sheet data including import custom sheet data and export custom sheet data, the bonded material monitoring system comprising:
a material tracking module for inputting inquiring instructions of the materials ready to be inquired and receiving material data corresponding to the inquiring instructions and provided by the logistic management database, and calculating and gathering statistics of the material data to generate a material consumption table; and
a material checking module for generating a theoretic stock values based on the material consumption table generated by the material tracking module, performing an inquiring process based on the theoretic stock values, the material data provided by the logistic management database and the custom sheet data provided by the material data, and generating abnormal messages and an abnormal analysis report when inquiring results mismatch.

2. The bonded material monitoring system of claim 1 further comprising a material canceling module for performing cancellation and overdue tax-paying processes based on the material data provided by the logistic management database and the custom sheet data provided by the custom management database.

3. The bonded material monitoring system of claim 1, wherein the material tracking module further comprising:
an inquiring unit for inputting the inquiring instructions of the material ready to be inquired to inquire material data corresponding to the inquiring instructions;
a data collecting unit for collecting for collecting the material data corresponding to the inquiring instructions and provided by the logistic management database;
a calculating unit for calculating bonded material values based on the material data collected by the data collecting unit; and
a statistic unit for gathering statistics of the bonded material values generated by the calculating unit to generate a material consumption table.

4. The bonded material monitoring system of claim 3, wherein the material consumption table comprises bonded material initial numbers, current import numbers, current withdraw numbers, current input numbers, labor production numbers, other consumption, labor consumption, current sale numbers and material reciprocal numbers.

5. The bonded material monitoring system of claim 3, wherein the inquiring unit comprises a user operation interface.

6. The bonded material monitoring system of claim 1, wherein the material checking module comprises:
a stock calculating unit for generating theoretic stock values based on the material consumption table generated by the material tracking module;
a difference ratio calculating unit for calculating difference ratios between the theoretic stock values and the material data provided by the logistic management database, between the theoretic stock values and the custom sheet data provided by the custom management database, and between the material data and the custom sheet data;
a comparing unit for comparing the difference ratios generated by the difference ratio calculating unit with a predetermined difference ratio, and generating the abnormal messages when comparing results mismatch; and
an analyzing unit for analyzing the abnormal messages generated by the comparing unit, and generating the abnormal report.

7. A bonded material monitoring method for working with an ERP system having a logistic management database and a custom system having a custom management database, and tracking and inquiring materials ready to be inquired, the logistic management database being used for storing material data including input data, output data, stock data, initial stock data and labor sheet data, the custom management database being used for storing custom sheet data including import custom sheet data and export custom sheet data, the bonded material monitoring method comprising:
inputting inquiring instructions of the materials ready to be inquired;
receiving material data corresponding to the inquiring instructions;
calculating bonded material values based on the material data;
gathering statistics of the bonded material values and generating a material consumption table;
calculating theoretic stock values based on the material consumption table;
calculating difference ratios between the theoretic stock values and the material data and between the theoretic stock values and the custom sheet data, and generating abnormal messages when comparing results mismatch; and
generating an abnormal analysis report based on the abnormal messages.
